(19) United States
(12) Patent Application Publication
(10) Pub. No.: US 2026/0220053 A1
(43) Pub. Date: Jul. 30, 2026

(54) A METHOD AND DEVICES FOR ENABLING SAFE DATA TRANSFER BETWEEN INPUT/OUTPUT DEVICE HANDLERS

(71) Applicant: Telefonaktiebolaget LM Ericsson (publ), Stockholm (SE)

(72) Inventors: Niklas LINDSKOG, LUND (SE); Peter ÖKVIST, Luleå (SE); Tommy ARNGREN, Luleå (SE); Patrik SALMELA, Jorvas (FI)

(73) Assignee: Telefonaktiebolaget LM Ericsson (publ), Stockholm (SE)

(21) Appl. No.: 19/145,007

(22) PCT Filed: Jan. 24, 2023
(86) PCT No.: PCT/EP2023/051704

§ 371 Date: Jul. 1, 2025

(51) Int. Cl. G06F 13/10; H04W 12/041; H04W 76/20

(52) U.S. Cl. CPC G06F 13/102; H04W 12/041; H04W 76/20

(57) ABSTRACT

A method of an IODH, managing a first set of IODs with a first IOD providing an ongoing session between a User Tag and a server. Receiving, from a second IODH, managing a second IOD of a second set of IODs, information on a beacon signal received by the second IOD. The information comprises IOD specific information and session specific information on the ongoing session. Initiating, based on the received information, a determination on whether at least part of an IOD managed by the second IODH is allowed or prohibited from taking part in the ongoing session. Managing, at least parts of the second IOD to take part in the ongoing session, in response to having become aware of that the at least parts of the second IOD is allowed to take part in the ongoing session and based on information on the beacon signal received from the second IODH.

### TECHNICAL FIELD

Disclosed are embodiments related to methods for enabling safe transfer of data associated with an ongoing session between two input/output handlers, and input/output handlers, adapted for execution of such methods.

### BACKGROUND

There are different solutions available in the market that enable wireless access, sharing and use of hardware resources available in a certain context, room or network, etc., like Apple-TV, Sun stateless terminals or video conferencing systems. However, all these solutions have in common that the users, in some way, are logged onto a corresponding communication system and what devices the communication system at hand holds are defined by the system itself.

A flexible solution and method that enable a secure association between a cloud based service and available devices, appearing in proximity of a user is known, where a user, registered and authenticated to a cloud service carries a user device, such as e.g. a user tag (UT) or a dongle, which may be anything from a constrained device to a smart device, associated to the cloud service. Such a service can be provided via one or more input/output devices (IODs), located in the vicinity of the user device that are associated, registered to and managed by an input/output device handler (IODH), which is capable of controlling or managing the IODs. However, the current solutions for changing which IODs that are to be involved in an ongoing session does not take into consideration that the IODs may be controlled by different IODHs.

### SUMMARY

In order to further improve the solution mentioned above, a mechanism for handling transfer and cooperation between IODHs is suggested.

According to one aspect a method of an IODH, here referred to as a first IODH, managing a first set of IODs, comprising at least one first IOD, providing an ongoing session between a User Tag (UT), and a server, is suggested, where the method comprise receiving information on a beacon signal received by a second IOD from another IODH, here referred to as a second IODH, where the second IODH is managing a second IOD of a second set of IODs, wherein the information comprises IOD specific information on the second IOD and session specific information on the ongoing session. The method also comprise initiating, based at least partly on the received information, a determination on whether at least part of a second IOD, managed by the second IODH, is allowed to or prohibited from taking part in the ongoing session, and managing, at least parts of the second IOD to take part in the ongoing session, in response to having become aware of that the at least parts of the second IOD is allowed to take part in the ongoing session and based, at least partly on information on the beacon signal, received from the second IODH. By applying the suggested method, it will be possible to extend the geographical area where a user will be able to access a service, provided as suggested herein.

According to another aspect, a method of a second IODH, handling information on a second IOD, managed by the second IODH, is suggested, where the method comprise receiving, from the second IOD, information on a beacon signal, wherein the information comprises IOD specific information on the second IOD and session specific information on a session, ongoing via at least parts of a first IOD, managed by a first IODH, and forwarding at least parts of the information on the beacon signal and an identity of the second IODH, to the first IODH. By applying the mentioned method, the second IODH enables for the first IODH to cooperate with the second IODH, with regards to a specific ongoing session, thereby enhancing the area in which a user will be able to access a service, provided as suggested herein.

According to yet another aspect, a first IODH, is suggested where the first IODH comprises processor circuitry, and a memory, comprising computer readable instructions, which, when executed by the processing circuitry, causes the first IODH to receive, information on a beacon signal received by the second IOD, from a second IODH, managing a second IOD of a second set of IODs, wherein the received information comprises IOD specific information on the second IOD and session specific information on the ongoing session. Based, at least partly, on the received information, the first IODH is caused to initiate a determination on whether at least part of an IOD, managed by the second IODH, is allowed to or prohibited from taking part in the ongoing session, and furthermore the first IODH is caused to manage, at least parts of the second IOD, to take part in the ongoing session, in response to having become aware of that the at least parts of the second IOD is allowed to take part in the ongoing session and based, at least partly, on information on the beacon signal, received from the second IODH.

According to another aspect a second IODH is suggested, where the second IODH comprise processor circuitry, and a memory, comprising computer readable instructions, which, when executed by the processing circuitry causes the second IODH to receive information on a beacon signal from the second IOD, wherein the received information comprises IOD specific information on the second IOD and session specific information on a session, ongoing via at least parts of a first IOD, managed by a first IODH. The second IODH is also caused to forward, at least parts of the information on the beacon signal and an identity of the second IODH, to the first IODH.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The accompanying drawings, which are incorporated herein and form part of the specification, illustrate various embodiments.

FIG. 1 illustrates an exemplifying signaling scheme according to one embodiment, illustrating how a session can be set up in a system, configured as suggested herein.

FIG. 2 illustrates a method at an IODH, managing an ongoing session and receiving information on a beacon signal, associated with the ongoing session, from another IODH.

FIG. 3 illustrates parts of the method illustrated in FIG. 2 in further detail, according to one embodiment.

FIG. 4 illustrates a method at an IODH, providing information on a beacon signal, associated with an ongoing session, to another IODH, managing the ongoing session.

FIG. 5 illustrates a signaling scheme where the method illustrated in FIG. 2-4 is presented.

FIG. 6 is a block scheme, illustrating a managing IODH, according to one embodiment.

FIG. 7 is a block scheme, illustrating a managing IODH, according to another embodiment.

FIG. 8 is a blocks scheme, illustrating an IODH, receiving information on a beacon signal from another IODH, according to one embodiment.

FIG. 9 is a blocks scheme, illustrating an IODH, receiving information on a beacon signal from another IODH, according to another embodiment.

### DETAILED DESCRIPTION

Although the flexible wireless access concept presented above may be implemented with just one single IODH, a possible network configuration may comprise a plurality of IODHs, each covering different geographical areas or jurisdictions, where each of these IODHs are managing different IOD domains. In one scenario, a company may e.g. have an IODH, operating as a managing node, covering all IODs, forming a private IOD domain within the company premises, whereas a city or local district may instead control public IODs, in a public IOD domain. In another scenario, a user may have an IODH, controlling IODs of a private IOD domain, arranged in his/her home, which may be referred to as a smart home, whereas a transport infrastructure enterprise may instead have a plurality of IODs capable of managing IODs in a vehicular context. Other IODHs may relate to operating IODs for e.g. National Security and Public Safety (NSPS) purposes.

The present disclosure is focusing on the situation where a user of an UT starts in a first geographical area where it utilizes a first set of IODs, handled or managed by one IODH, here referred to as a first IODH. The UT then moves from the first geographical area to a second area where both the first set of IODs and a second set of IODs, handled or managed by another IODH, here referred to as a second IODH, exists, with IODs of both sets now capable of receiving a beacon signal associated with a certain ongoing session from the UT, and capable of providing capabilities to the UT.

When an IOD, handled by the second IODH, receives and recognizes a beacon signal from the UT, the second IODH informs the first IODH of the fact that it has recognized a beacon signal, received from an IOD which the first IODH is not presently managing itself. The second IODH informs the first IODH of IOD specific information, such as the signal strength of the beacon signal, when received by the IOD, and possibly also capabilities available at the IOD, as well as session dependent information, in the form of a session identity, allowing the second IODH to associate the IOD to an ongoing session. An IODH typically knows the capabilities available at the IODs which it is managing from internal storage or storage accessible to the IODH, but need to be informed of capabilities of IODs managed by another IODH. The signal strength will be needed for determining if the IOD or certain capabilities of the IOD is/are to be preferred and used for providing the ongoing session.

The first IODH responds to such information, by determining if the IOD, controlled by the second IODH, may be included in the ongoing session, presently handled by the first IODH, i.e. if the two IODHs are allowed to cooperate, when handling the ongoing session. This may typically be done by consulting a policy, defining one or more criteria for making such a decision. If such a cooperation between IODHs is allowable, signaling associated with the mentioned ongoing session will, from now on, be forwarded from the second IODH to the first IODH. In the first IODH such forwarded information will be handled similarly to information associated with the ongoing session and forwarded to the first IODH from an IOD managed by the first IODH, i.e. if the signal strength of a beacon signal, associated with the mentioned ongoing session, and received by an IOD, managed by the second IODH, justifies that this IOD should be included in the IOD set providing the ongoing session to the mentioned UT, either by adding the IOD to the session, or by replacing a presently used IOD with the mentioned IOD, the first IODH will take also this IOD into account for updating of the active IOD set, even though the IODs of such a set will, from now on, be managed by different IODHs.

As an extension to the approach mentioned above, also the following scenario can be assumed, where all the IODs providing the ongoing session are managed by the second IODH, i.e. all IODs previously managed by the first IODH, when providing the ongoing session, have now been deleted from the session or replaced by other IODs, not managed by the first IODH, so that the first IODH is now only handling IODs managed by the second IODH and where IOD and session related information is forwarded from the second IODH to the first IODH. In the mentioned scenario, it may be determined that the session is to be transferred from the first to the second IODH, resulting in that the second IODH will handle the session without any further involvement from the first IODH.

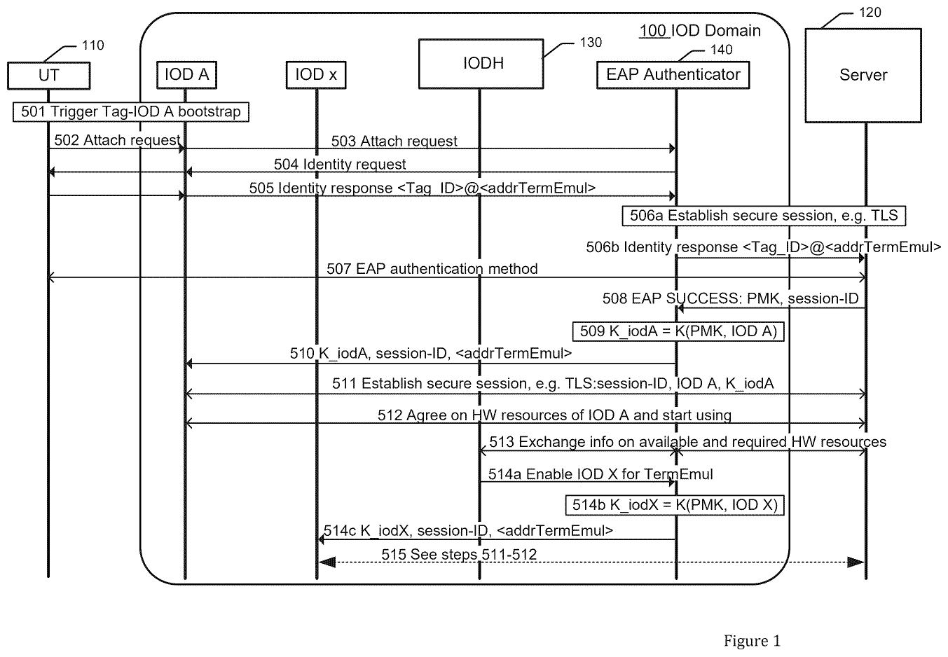

A basic scenario, illustrating how a session can be set up in a system, configured as suggested herein will now be described in further detail, with reference to the signaling scheme of FIG. 1. In the scenario of FIG. 1, a user who is using or carrying a user tag (UT) 110, e.g., dongle, wants to utilize a proximately located I/O user device (IOD), here represented by IOD A, forming part of an IOD domain 100, for being able to access a service, provided by server 120. The user may trigger such a process e.g. by pushing a button on the UT 110, or by activating the UT 110 in any other way, thereby initializing a bootstrapping process 501.

The UT 110 sends 502, via IOD A, an attach request to the system to which IOD A is connected. The attach request is forwarded 503 by IOD A to an EAP Authenticator 140, in the system. The EAP authenticator 140 may alternatively be a local process in IOD A or in an I/O user device handler (IODH) 130, managing IOD domain 100, or may reside as a separate entity in the IOD domain 100. Therefore, when referring to the EAP Authenticator 140 below, this may, alternatively be construed as referring to the IODH 130, in case it also holds EAP Authentication capabilities. The attach request is then processed by either the IODH 130, or the EAP authenticator 140, depending on the relevant configuration.

The EAP authenticator 140, or IODH 130, responds 504 to the attach request with an EAP identity request, which is communicated back to the UT 110, typically with an EAP response. The UT 110 responds to such a request with providing its identity, identifying the UT 110, or the holder of UT 110, and pointing to a user terminal emulation server, here referred to as server 120, capable of providing a service to the user of the UT 110 via one or more of the IODs, here represented by IOD A.

The server 120 and other system components may correspond to one or more networked physical computers or may correspond to application server operational functionality collectively provided by any number of networked physical computers (e.g., in a cloud computing environment) which operate in accordance with one or more embodiments disclosed herein. In some embodiments, the user terminal emulation server, herein commonly referred to as a server, and other system components can be referred to as a cloud phone, because of the possible virtualization of mobile phone functionality into a cloud computing environment.

The UT identity, mentioned above, may e.g. be arranged as:
<hash(user_pub_key)>@<user_terminal emulation application_address>.

The hash of the public key provides a more compact identity of the public key of the UT 110 and may be included with a network address of the server 120. As explained above, the server 120 may provide a communication service function corresponding to, e.g., an over-the-top Voice Over Internet Protocol (VoIP) service, Netflix service, Facebook service, Microsoft Teams meeting service, video streaming service, DRM content viewing service, social media service, video meeting service, Internet browser service or a cellular communication service, accessible to the user of an UT 110, whenever the UT 110 is located withing the range of the IOD domain 100, connected to the described system.

When the UT 110 has been issued to the user, it may have also been associated with the corresponding server 120, meaning that the UT 110, in addition to its own credentials, such as e.g., private/public key pair, can be configured to have reachability information of the server 120, e.g., in the form of a Fully Qualified Domain Name (FQDN), as well as credentials for authentication of the server 120 e.g., in the form of a public key of the server 120. Likewise, the server 120 may have been configured with the credentials of the UT 110, e.g., the public key of UT 110, resulting in that the server 120 knows that the UT 110 is an entity that is authorized to request data streams and services from the server 120.

The EAP authenticator 140 identifies the server 120 based on the realm part of the identifier and forwards the request to the server 120, which is here acting as an EAP server.

The EAP authenticator 140 first establishes 506a a secure connection between itself and the server 120. The EAP messages are passed over that secure channel between the authenticator 140 and the server 120. The secure connection may e.g. be a Transport Layer Security (TLS) session. The EAP Authenticator 140 knows that it needs to talk with the server 120, based on an identity (realm part of identity) received 506b in an EAP Identity Response. It also knows it needs to have a secure channel with the server 120. Thus, if there is not an existing secure session (typically TLS), the EAP Authenticator 140 creates such a secure session and then forwards 506b the Identity response to the server 120. The communication between the EAP Authenticator 140 and the server 120, while using EAP messages, may e.g. be carried by DIAMETER or RADIUS protocol.

The server 120 and the UT 110 will perform an EAP exchange 507 in order to authenticate the UT 110 to the server 120. The server 120 may also be authenticated to the UT 110. The authentication may require multiple messages to be exchanged between the UT 110 and the server 120 via the EAP authenticator 140.

Once the UT 110, and possibly also the server 120, is/are successfully authenticated, the server 120 send 508 a final EAP SUCCESS message to the EAP authenticator 140. The EAP SUCCESS message also carries the master key, e.g., pairwise master key (PMK), and the session-ID, where the PMK key can be referred to as the master key for the session-ID, the PMK key can be used to derive more keys for IODs, e.g., IOD X, if it is required that also this IOD is added to the session.

In an optional operation, the UT 110 at this stage may derive the master key, e.g., PMK key, but it will not (necessarily) be used by the UT 110. The master key can be used if the user wants to authorize additional IODs, e.g., IOD X, assuming the user is more in control of which IODs that are added to the session, by having to actively (possibly even physically) add more IODs to the session. A beacon protection key may also be derived from the PMK, where EAP authenticator 140 also derives a beacon protection key which it uses itself or provided to the relevant IODH, thereby allowing the IODH 130 to use this key for verifying received beacons.

The EAP authenticator 140 generates 509 an IOD specific key K_iodA from the received keying material to be used for streaming data between the server 120 and IOD A. Generating the IOD specific key K_iodA may include using the received keying material as is, or may include performing a computational operation on the received key material, such as by hashing a concatenation of the keying material and the identifier of IOD A and/or using another key derivation function (KDF), based on PMK and IOD specific information.

The EAP authenticator 140 provides 510 the IOD specific key K_iodA to IOD A, directly or via the IODH 130, together with the session-ID, exported by the server 120 and the address (e.g. FQDN) of the server 120. IOD A can use the received data to establish 511 a secure channel (e.g., TLS) between itself and the server 120. It is noted that, in some embodiments, to establish the secure channel between the IOD and the server 120, there needs to be a shared secret (which is the first IOD specific key K_iodA), an identifier for who is connecting to the server 120 and that is used to derive an IOD specific key, and an identifier (session-ID) that the server 120 can use to lookup the context from where it can derive the corresponding K_iodA.

In operation 511, IOD A can use the session-ID to indicate to the server 120 the session/keying material/authentication context to which the connection request relates. The server 120 locates context and associate keying material based on received session-ID. As background, IOD A is to connect with the server 120, using a secure channel so that the server 120 can stream or receive data from IOD A, such that IOD A needs to have keying material which it can use to establish a secure connection and the server 120 needs to verify that IOD A is authorized to send data in the session. So, the session ID that was sent in operation 508 is what IOD A can send to the server 120 so it knows that the request relates to the authentication session that was setup for the session ID, and then locates its copy of the PMK key and any other keys, negotiated during the authentication.

The IOD uses its own identifier (e.g. IOD A) as a kind of username. The IOD A thereby tells the server 120 who it is. The EAP authenticator 140 has derived an IOD A specific key based on the PMK key, e.g., by concatenating the IOD A ID and the PMK key and then hashing the concatenated string, and may truncate the hash value to a defined length. The server 120 needs to know the ID for the IOD A, so that it can derive the same IOD A specific key provided to IOD A in, e.g., step 510.

The server 120 uses the IOD identifier to derive IOD A specific key (K_iodA). The IOD A uses the received key K_iodA as the password/authentication credential to authenticate to the server 120. In this operation IOD A and the server 120 share the same IOD A specific key which is used as a shared secret that the server 120 and IOD A use to authenticate each other and establish a secure channel therebetween. The server 120 verifies, via PSK-based authentication, that the IOD indeed possesses a valid session key (K_iodA) and is thus authorized to connect to the server 120 and exchange data with it. A secure channel is established between IOD A and the server 120.

After successful authentication, IOD A can indicate 512 its UI capabilities (e.g., display, speaker, microphone, etc.) to IODH 130, which, based on the UI capabilities, can enable data streaming to and/or from IOD A. The user may have defined policies to the IODH 130, or the server 120, regarding what operations can be enabled automatically (e.g., streaming video to a display device for the communication service) and what operations requires explicit user consent before performing (e.g., to enable microphone use for the communication service), or preconfigured policies may be applied. In a parallel optional operation, the IODH 130 may determine if other IODs in the vicinity of the user, which have UI capabilities that can be used to provide the communication service to the user, are to be included in the ongoing session. These operations can provide the server 120 with information about what IOD capabilities could be available to the user for the service, provided in the ongoing session. Whether the IODH 130 can allow change of IODs to participate in the ongoing session may depend on e.g. which service and/or application that is running in the server 120 or other policies, applied by the IODH 130.

Alternatively, as already mentioned above, the IODH 130 may itself be capable of also acting as an EAP authenticator 140, in which case much of the “communication” between authenticator and IODH 130 is simplified, such as where the PMK is used directly by the IODH 130 to securely communicate with the server 120, or the already established secure session is re-used.

When the IODH 130 independently or triggered by the server 120, concludes, that a certain other IOD, such as e.g. IOD X, should join the ongoing session, established between the user and the IOD domain 100, the IODH 130 can request 514a the EAP authenticator 140 to generate credentials also for IOD X, e.g., K_iodx, session-ID, server 110 FQDN and provide those credentials to this other IOD.

The decision that a further IOD is required may be dependent upon one or more of: which application and/or service the user activates; ongoing application and/or service; available devices and/or their respective UI capabilities; and/or a defined configuration by the user to always try to find an IOD which has certain UI capability(ies). If the IOD receives 514c a trigger (e.g., where the trigger is the credentials etc.) needed to connect to the server 110 from the EAP authenticator 140, IOD X performs operations similar to the ones described above in operations 511 to 512.

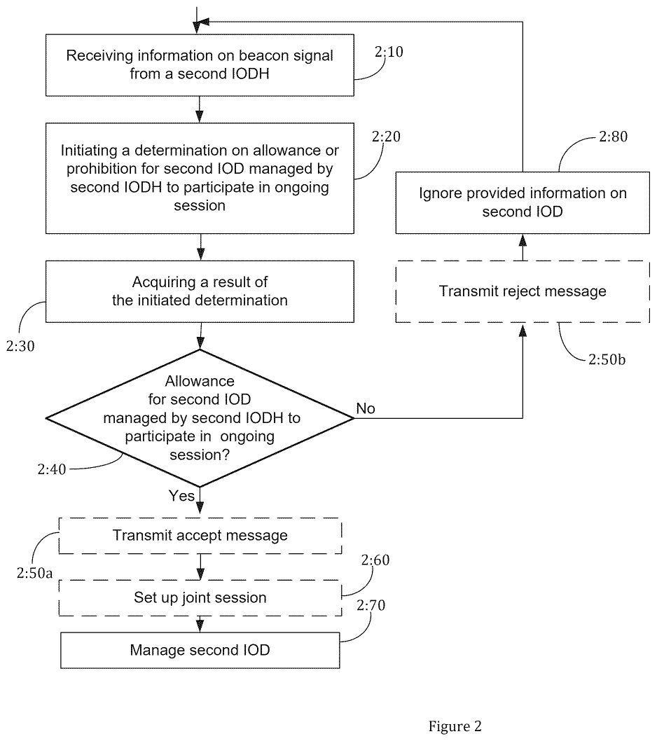

A method executable at an IODH, here referred to as a first IODH, will now be described in further detail with reference to FIG. 2. The first IODH is managing one or more IODs, which are presently providing a session between a server and an UT, where the first IODH is informed of a beacon signal, associated with the mentioned session, where the beacon signal has been receive by an IOD, managed by an IODH other than the first IODH, here referred to as a second IODH.

In a first step 2:10, the first IODH is receiving information on a beacon signal, received by a second IOD, managed by a second IODH, where the received information, which comprise IOD and session specific information, has been transmitted from, or forwarded by the second IODH. In another step 2:20 a determination on whether at least a part of the second IOD, is allowed to, or prohibited from, taking part in the ongoing session, is initiated. Such an initiation may involve the first IODH taking a decision based on policies, applicable by the first IODH, or the initiation may involve, requesting for a decision from an external entity, such as e.g. the server, providing a service via the ongoing session. A result of such a determination is acquired, according to step 2:30 and 2:40, meaning that either the two IODHs are allowed to cooperate when managing the ongoing session, or such a cooperation is prohibited.

If the first IODH acquire an affirmative result, according to the “Yes” branch of step 2:40, the process can proceed by managing the second IOD, when taking part in the ongoing session, according to step 2:70. According to step 2:70, the first IODH is managing at least parts of the second IOD, wherein the managing particularly involve the second IOD to take part in the ongoing session, in case it was determined in step 2:40, that at least parts of the second IOD is allowed to take part in the ongoing session, and also based, at least partly, on information on the beacon signal, received from the second IODH, i.e. in case such received information justifies that the second IOD is to take part in the ongoing session.

More specifically, the IOD specific information comprise at least an identity of the second IOD, allowing the first IODH to be aware of the IOD under consideration, and an indication of the signal strength of the beacon signal when received by the second IOD, allowing the first IODH to be able to evaluate if the second IOD is to be part of the IOD set, providing the ongoing session to the UT, once the first IODH has become aware of that the IOD is allowed to participate in the session, and that the two IODHs are allowed to cooperate with each other when providing one and the same session. The session specific information comprises at least a session identity, allowing the first IODH to identify which session the beacon signal is associated with.

Unless the first IODH is not already aware of the capabilities of the second IOD, the IOD specific information will also comprise at least one capability that is either available at the IOD, requested by the UT, or both. In a scenario where IODs only comprise one capability each, such information may be retrieved e.g. from storage available to the first IODH, once the identity of the second IOD has become available to the first IODH, and thus, such information will not be required in the received information. In case there are a plurality of capabilities available at the IOD, such information will, on the other hand, be needed in the received information, where availability of the different capabilities may depend on e.g. if they are presently used by another session or not, whether they are allowed to be used under the present circumstances, such as e.g. by the UT, at the relevant time of day, or in the present geographical area.

The determining step 2:20 may only be initiated in case the first IODH has first managed to authenticate the beacon signal as a legitimate beacon signal, typically by verification of content of the beacon signal, specially adapted for this purpose. As mentioned above, the determination step 2:20 may be executed based on a policy, applicable at the first IODH, wherein such a policy may be based on one, or a combination of a plurality of rules. Such rules may be IOD specific, such that e.g. only certain IODs are allowed at the same time by a session. Other rules may be IOD domain specific, only allowing certain groups of IODs to provide a session. Rules may also, or alternatively, be IODH specific, allowing only certain IODHs to cooperate with each other, whereas service specific rules may allow or deny the second IOD to form part of an IOD set, e.g. based on which specific service that is provided via the ongoing session. Thereby, a security critical service, such as e.g. a service, involving a monetary transaction, or a log-in procedure, may only be accepted if handled by one or more specific IODH, and only when this IODH is handling this respective service all alone, without involvement of any other IODH, or only in cooperation with one or more specific IODHs.

Alternatively, or in addition, the mentioned policy may be based on security classifications, meaning that a certain service, provided via an ongoing session, may require a certain level of security from the infrastructure, making it possible to provide this service to the UT. By way of example, a service involving monetary transactions may allow some capabilities and/or some IODs to participate, whereas other IODs are not allowed to participate in such a session. According to another example, the combination of parts of IODs, such as e.g. how certain capabilities of different IODs are allowed to be combined within a certain IOD set or among combinations of IOD sets may be determined, based on certain security levels, which may be related e.g. to which communication service that is applied.

The determination according to step 2:20 may result in an allowance or a denial, according to step 2:40, without resulting in any notification of such a determination to the second IODH, but simply resulting in that information forwarded from the other IODH is simply processed accordingly, in case of allowance, or discarded, in case of denial. Alternatively, the mentioned decision may result in that either an accept message is provided to the second IODH, according to step 2:50a, in case it was determine that the second IODH is allowed to take part in the ongoing session, or in a reject message, according to step 2:50b, in case it was instead determined that the second IOD is prohibited from taking part in the ongoing session.

Once the first IODH becomes aware of that the second IOD may participate in the ongoing session, the first IODH may set-up a joint session with the second IODH, according to optional step 2:60, and use such a joint session for the ongoing signaling between the two IODHs. Although not shown in FIG. 2, the awareness of an affirmative result of the mentioned determination may also result in a session key update procedure, comprising that an IOD specific session key is generated by the first IODH or the EAP authenticator, after which this key is transmitted to the second IODH, where the IOD specific session key is typically also provided with a pointer to the server, providing the relevant service via the ongoing session, and a session ID, identifying the ongoing session.

In step 2:70 the first IODH may manage the second IOD to either take complete part in the ongoing session, or to only partly take part in the ongoing session, e.g. such that only one or more capabilities of the second IOD are allowed to take part in the ongoing session. In addition to being able to manage the second IOD to take part in the ongoing session, according to step 2:70, the first IODH may manage the second IOD to replace all or some of the capabilities of the second IOD with all or some of the capabilities of another IOD. According to yet another embodiment, some or all capabilities of the second IOD may be deleted from the session, e.g. once they are considered no longer to be required. Alternatively, an IOD or parts of an IOD, e.g. some capabilities of an IOD may, in the ongoing session, be replaced with the second IOD or parts of the second IOD. Alternatively, allowance for the second IOD to participate in the ongoing session may be allowed only under certain conditions. The managing of the second IOD according to step 2:70 may proceed until the ongoing session is terminated, or until it is determined that the second IOD is no longer allowed or preferred to participate in the ongoing session, wherein the described method is replaced by managing one or more IODs in a conventional manner.

In case the second IOD is not allowed to participate in the ongoing session, the first IODH will ignore provided information on the second IOD, according to step 2:80, without necessarily requiring any message, indicating a rejection. However, if a message, indicating this to the second IODH, is to be provided to the second IODH, a reject message may be transmitted to the second IODH, as indicated with step 2:50b.

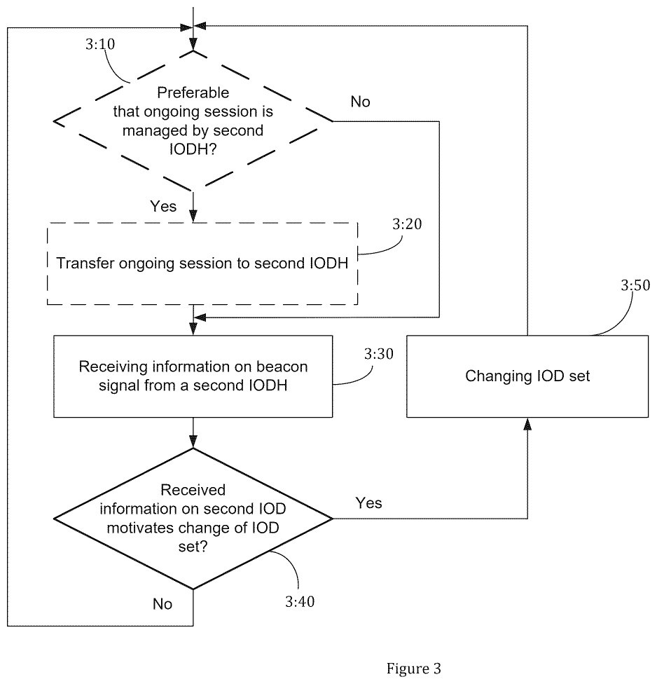

Some possible events, associated with managing of the second IOD, which may be executed in step 2:70 of FIG. 2, in addition to what has already been mentioned above, with respect to step 2:70, will now be described in further detail, with reference to FIG. 3. According to optional step 3:10, during the ongoing managing, it may, at any time, be determined by the first IODH that the ongoing session should be managed by the second IODH, instead of by the first IODH, as indicated by the “Yes” branch of step 3:10, followed by another step 3:20, where the ongoing session is transferred to the second IODH. Such a transfer may be permanent, so that once transferred the ongoing session is then managed by the second IODH until the session is terminated, or the transfer may be temporary, so that the session may later, whenever required, be transferred back to the first IODH. A temporary transfer may e.g. be executed based on the current majority of IODs or capabilities used by an ongoing session, so that a transfer is maintained as long as the respective IODH is managing a majority of the used IODs or capabilities, or the transfer may be executed only during a certain part of the day or week or during a certain time interval.

Steps 3:10 and 3:20 are presented as unconditional steps, where the transfer is preceded by instructing the second IODH to take over managing of the ongoing session, and, thus, IODs used by this session. However, alternatively, a request for the mentioned transfer may be provided from the first IODH to the second IODH, whereas a transfer is executed only if the second IODH accepts such a requested transfer. In case of no acceptance of the requested transfer, the ongoing session will continue to be managed by the first IODH.

The reason for such a transfer may e.g. be that it is determined that no IOD managed by the first IODH is no longer involved in the ongoing session, i.e. all IODs providing the ongoing session are now managed by another IODH, in the present example, the second IODH. During managing, new information on a beacon signal, received by the second IOD may be receive from the second IODH, when the first IODH is still managing the session, as indicated with step 3:30. In a subsequent step 3:40, it is determined if the received information motivates a change of the IOD set, i.e. if the second IOD, in some way, is to be involved in the present IOD set, used for the ongoing session. If this is the case, the IOD set is changed, so that the second IOD, or parts of the second IOD, i.e. one or more capabilities of the second IOD, is either added to the ongoing session, removed from the ongoing session, or replacing another IOD or some capabilities of another IOD, as indicated with step 3:50, whereas if this is not the case, the process is repeated, possibly by executing optional steps 3:10, possibly followed by optional step 3:20, and by then awaiting reception of additional information, according to step 3:30.

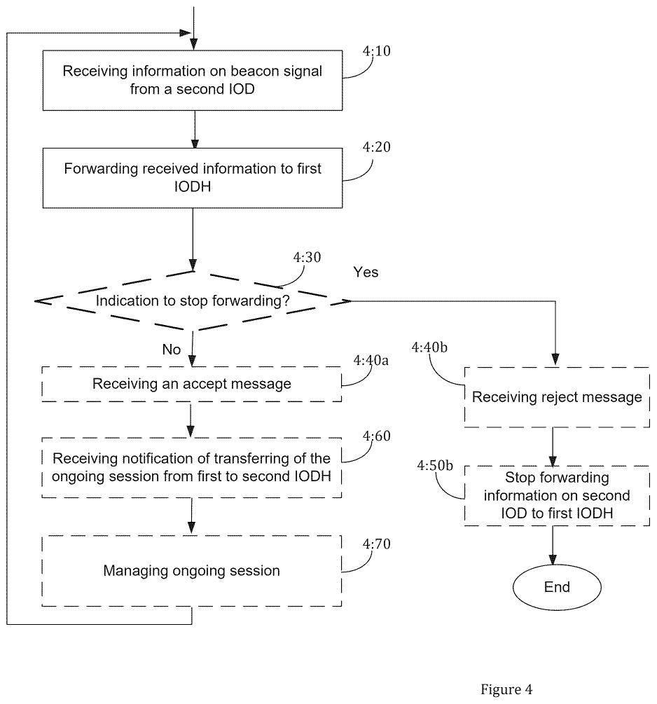

A method as executed in an IODH, herein referred to as a second IODH, where the second IODH has received a beacon signal from an IOD, related to an ongoing session, which is managed by an IODH, other than the second IODH, here referred to as a first IODH, as suggested above, will now be described in further detail, with reference to FIG. 4.

In a first step 4:10 of FIG. 4, the second IODH is receiving information on a beacon signal from a second IOD. As already mentioned above, the second IODH identifies the second IOD as an IOD, which is belonging to, or providing, an ongoing session, managed by another IODH, here the first IODH. Such identification can be achieved based on IOD specific and session specific information, where the IOD specific information may comprise an IOD identity, uniquely identifying the second IOD, and the session specific information may comprise a session identity, uniquely identifying the ongoing session. The IOD specific information may also comprise an indication of the signal strength of the beacon signal when received by the second IOD and optionally also an indication of at least one capability, requested by the UT, and available at the second IOD, or both types of capability information may be provided. The second IODH typically responds to reception of such information by forwarding the received information to another IODH, here referred to as a first IODH, as indicated with step 4:20.

Alternatively, the second IODH may determine not to forward any information to the second IODH, e.g. for the reason that policies known to the second IODH prohibits such a cooperation between the two IODHs.

Forwarding of information to the first IODH may be executed without the second IODH receiving any indication to stop the forwarding by the first IODH, as indicated with the “No” branch of step 4:30. Alternatively, the first IODH, disapproving with the second IOD being involved in the ongoing session, may provide a reject message to the second IODH, resulting in that the second IODH receives the reject message, according to step optional 4:40b, as a confirmation to stop forwarding information on the second IOD to the first IODH, according to optional step 4:50b, after which the suggested method is terminated. If instead no indication to stop forwarding is applied, the forwarding will be continued, but forwarded information may be considered or discarded by the first IODH without making the second IODH aware of this, according to the “No” branch of FIG. 4. If confirmation of the determination of the first IODH is applied, the second IODH may receive an accept message, according to optional step 4:40a, notifying the second IODH that the forwarded information will be considered by the first IODH. An accept message may indicate an unconditional accept or a conditional accept, accepting the second IOD.

According to another optional step 4:60, the second IODH may receive a notification, e.g. in the form of an instruction, from the first IODH to transfer the ongoing session from the first to the second IODH, after which the session can be managed by the second IODH, according to optional step 4:70. As an alternative to the unconditional transfer, mentioned above, the second IODH may instead receive a request for a transfer from the first IODH, thereby allowing the second IODH to accept or reject such a request. In case of acceptance the requested transfer is executed and the ongoing session is managed by the second IODH instead, whereas, in case of a rejection, the first and second IODH continues to manage respective IODs in an unchanged manner.

Before, the mentioned transfer is being executed, the IOD specific session key, associated with the ongoing session need to be updated at the second IOD, according to a session key procedure already described herein. Consequently, the second IODH may receive an IOD specific session key from the first IODH, after which this key is forwarded to the second IOD. The session key may be forwarded together with one or more of an indication of capabilities that are allowed to participate in the ongoing session, thereby identifying capabilities which can be considered for the session for the second IODH, a pointer to the server, thereby identifying the server, providing the ongoing session, and a session ID, identifying the ongoing session to the second IODH.

Forwarding of information to the first IODH may continue until a reason to interrupt forwarding has occurred. Such a reason may e.g. be that no more beacon signals, comprising IOD specific information on the ongoing session, is received by the second IODH. This may be determined e.g. based on absence of received information from start to expiry of a timer. According to another embodiment, the second IODH may receive a reject message associated with the second IOD and the ongoing session, after some content has been received and processed by the second IODH, or forwarding may be terminated based on that the ongoing session is terminated.

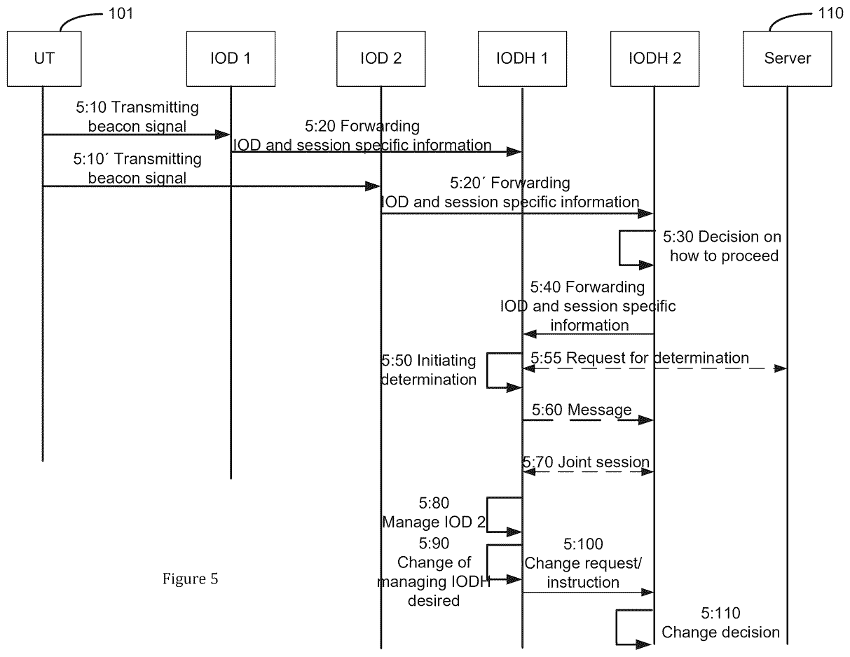

FIG. 5 is a signaling scheme, illustrating how two IODHs, IODH 1, or first IODH and IODH 2, or second IODH, may interact in order to maintain an ongoing session in a most efficient way, according to some embodiments. As a prerequisite, the presented scenario is supposed to disclose a UT 101, having access to a service via an ongoing session, provided from server 120. Initially, the service is provided from server 110 to UT 110 via IOD 1, having received a beacon signal from UT 110, as indicated in step 5:10, and having forwarded relevant information on such a received beacon signal to IODH 1, managing IOD 1, as indicated in step 5:20. Although the two mentioned steps are only indicated as respective single steps, it is to be understood that in a typical scenario these steps are repeated at a certain interval, typically as long as the beacon signal can be received by IODH 1.

In the given example another IOD, here referred to as IOD 2, is also receiving the transmitted beacon signal, at a later occasion in time, here illustrated with step 5:10′. One reason why also IOD 2 is now capable of receiving the beacon signal may be that the UT 101 has moved, so that now both IOD 1 and IOD 2 are within range of UT 101. IOD 2 responds by forwarding IOD and session specific information, based on information of the beacon signal to an IODH, managing this IOD, which in the present example is an IODH other than IODH 1, namely IODH 2, as indicated with step 5:20′. It is to be understood that at this time instance also IOD 1 may or may not receive the same beacon signal. If received, also IOD 1 is forwarding information to IODH 1, corresponding to previous step 5:20.

At IODH 2, the received information on the beacon signal is evaluated for determination on how to handle this information, as indicated with step 5:30. In the given example, such a determination is executed internally. IODH 2 may at this stage determine that IODH 1 and IODH 2 are either allowed or not allowed to interact with each other. In the latter scenario, the present invention, will not be able to execute, which may result in that further forwarded information may be ignored by the second IODH. In the present example it is, however, assumed that IODH 2 determines that information on IOD 2 is to be forwarded to a relevant IODH, identified, at least partly, based on the acquired information, possibly in combination with additional information, available e.g. from a storage of or accessible to IODH 2.

In a next step 5:40, IOD and session specific information is forwarded to the IODH, managing the mentioned ongoing session, i.e. IODH 1. IODH 1 responds to reception of information on an IOD not managed by itself, by initiating determination on how to handle this information, as indicated with step 5:50. Initiating such a determination may, according to one embodiment mean that IODH 1 itself takes the required decision, based on the acquired information, possibly in combination with policies or rules available to IODH 1. According to an alternative embodiment, a request on a decision, or an assistance in taking a decision, is provided to an external entity capable of providing such a decision or information. In the present example, step 5:50 also includes, requesting server 110 for a decision, as indicated with optional step 5:55.

Once IODH 1 has taken a decision, it can proceed by handling forwarded information accordingly. In case the decision is a denial, i.e. IOD 2 is not allowed to take part in the ongoing session, presently managed by IODH 1, forwarded information will be ignored by IODH 1. Such a scenario may be executed without noticing IODH 2 about it, meaning that IODH 2 may continue to forward information which is not considered at IODH 1, or IODH 1 may provide a message, such as e.g. a denial message to IODH 2 making IODH 2 aware of the denial, as indicated with optional step 5:60, so that it can stop to forward the information to IODH 1. In a similar manner, an allowance of forwarded information, and, thus, of the IODHs to cooperate, so that IOD 2 can take part in the ongoing session, may result in processing of forwarded information by IODH 1 without notifying IODH 2 of the allowance, or a message, indicating the allowance, may be provided in step 5:60.

An allowable decision may also be followed by IODH 1 setting up a joint session between IODH 1 and IODH 2, as indicated with another optional step 5:70, so that this joint session can then be used for the continued signaling, related to the ongoing session, between the mentioned IODHs. As indicated with step 5:80, IODH 1 then temporarily manages IOD 2 accordingly, such that IOD 2 can temporary or permanently be included into the IOD set, used by the ongoing session, by adding IOD 2 or replacing another IOD with IOD 2, whenever this may be desired. Furthermore, such managing may later include removing IOD 2 from the mentioned IOD set, if required. In a corresponding way, only parts of IOD 2, typically, in the form of one or more capabilities, may be managed, rather than the complete IOD. It is to be understood that a temporary managing by IODH 1, will rely on the progress of the ongoing session, such that the managing will continue as long as the ongoing session remains active, whereas, a termination of the ongoing session will result in that each IOD set will again be managed by the IODH, which was originally allocated to the respective IOD set.

According to another embodiment, which may be initiated at any time, a desire for a change of managing IODH may arise, as indicated with step 5:90, e.g. due to that no IOD managed by IODH 1 is any longer actively taking part in the ongoing session. Such a scenario, where there is still at least one IOD or parts of at least one IOD, actively providing the ongoing session, where these at least parts of an IOD are managed by IODH 2, may result in that it is determined that a change of IODH would be in place. Such a decision may result in either an instruction to IODH 2 to take over the managing of an IOD set, here represented by IOD 2, or a request or inquiry, requesting IODH 2 to accept such a transfer, and to execute the transfer if the request is accepted by IODH 2. Such a notification is indicated with step 5:100, whereas an actual change is executed by IODH 2 in step 5:110, unless such a transfer is denied, typically, by IODH 2 providing a message, indicating such a denial to IODH 1.

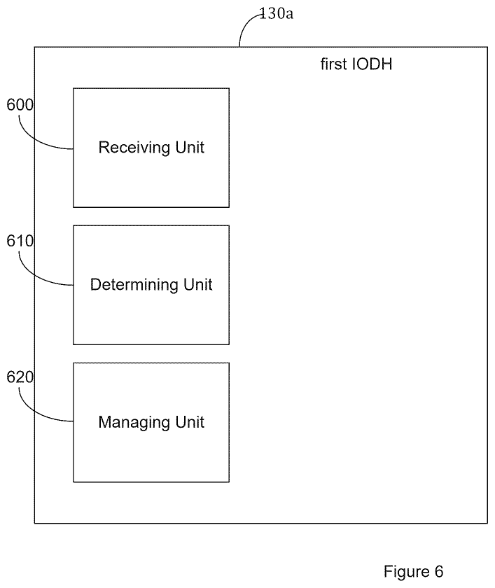

An IODH, configured to execute a method disclosed in any of the embodiments above, referring to the first IODH, i.e. an IODH capable of accepting forwarded information on an IOD, managed by another IODH, will now be described in further detail, with reference to FIG. 6. FIG. 6 disclose a first IODH 130a, capable of managing a first set of IODs, comprising at least one first IOD, providing an ongoing session between a UT, and a server. The IODH 130a comprising a receiving unit 600, configured to receive information on a beacon signal, received by a second IOD of a second set of IODs, from a second IODH, managing the second IOD, wherein the received information comprises IOD specific information on the second IOD and session specific information on the ongoing session. The first IODH 130a also comprises a determining unit 610, configured to initiate a determination on whether at least part of an IOD managed by another IODH, herein referred to as second IODH, is allowed to or prohibited from taking part in the ongoing session, wherein the mentioned initiation is based, at least partly, on the received information. The first IODH 130a also comprise a managing unit 620, configured to manage, at least parts of the second IOD to take part in the ongoing session, in response to having become aware of that the at least parts of the second IOD is allowed to take part in the ongoing session and based, at least partly, on information on the beacon signal, received from the second IODH. Furthermore, the first IODH 130a comprise a transmitting unit 630, enabling the first IODH 130a to provide information to, and respond to the second IODH.

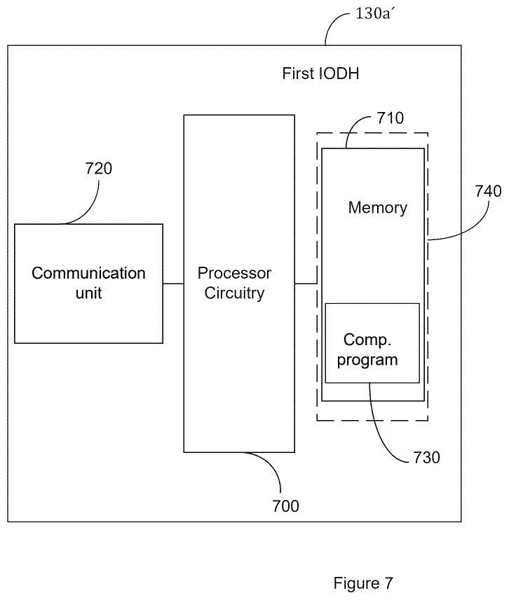

According to another aspect, a first IODH 130a′ is disclosed according to FIG. 7, which comprises processor circuitry 700, and a memory 710, comprising computer readable instructions, which, when executed by the processing circuitry 700, causes the first IODH 130a′ to receive information on a beacon signal, received by the second IOD, via a communication unit 720, from a second IODH, managing a second IOD of a second set of IODs, wherein the received information comprises IOD specific information on the second IOD and session specific information on the ongoing session, after which the second IODH 130a′ is configured to initiate, based at least partly on the received information, a determination on whether at least part of the second IOD, managed by the second IODH, is allowed to or prohibited from taking part in the ongoing session. The first IODH 130a′ is also configured to manage, at least parts of the second IOD to take part in the ongoing session, in response to having become aware of that the at least parts of the second IOD is allowed to take part in the ongoing session, based, at least partly on information on the beacon signal, received from the second IODH. The memory 710 can be any combination of random access memory (RAM) and/or read only memory (ROM). The memory 710 also comprises persistent storage, which, for example, can be any single one or combination of magnetic memory, optical memory, solid-state memory or even remotely mounted memory. The processing circuitry 700 may comprise e.g. one or more central processing unit (CPU), multiprocessor or digital signal processor (DSP).

According to one embodiment, the first IODH 130a′ is configured to handle IOD specific information, comprising an identity of the second IOD, and an indication of the signal strength of the beacon signal when received by the second IOD, wherein the session specific information comprises a session identity. The first IODH 130a′ may also be configured to handle IOD specific information, which may comprising also an indication of at least one capability, requested by the UT, and/or IOD specific information, comprising an indication of at least one capability, available at the second IOD.

According to one embodiment, the first IODH 130a′ is configured to initiate the mentioned determining in response to having authenticated the beacon signal as a legitimate beacon signal.

According to one embodiment the first IODH 130a′ is configured to initiate the determining based on at least one of execution of a first policy available to the first IODH, and a response to a request for the determination, transmitted to the server. In case the determining is based on execution of a first policy, available to the first IODH 130a′, such a first policy may be based on various types of rules, which may comprise at least one of: IOD specific rules; IOD domain specific rules, IODH specific rules, and service specific rules. The first IODH 130a′ may be configured to apply a first policy, which is based on security classifications, wherein such security classifications may comprise at least one of: comparing activities, executed by the ongoing session to at least one predefined security level, and comparing at least parts of the second IOD to at least one predefined security level.

Following a determination, as suggested above, a message, indicating the determination, may be sent from the first IODH to the second IODH. For enabling such a scenario, the first IODH 130a′ is, according to one embodiment, configured to transmit an accept message to the second IODH, where the message is indicating that at least part of the second IOD is allowed to take part in the ongoing session, in case it was determined, by the first IODH, that such an action is allowed, or to transmit a reject message to the second IODH, where such a message is indicating that at least part of the second IOD is prohibited from taking part in the ongoing session, in case it was determined, by the first IODH, that such an action is not allowed.

The first IODH 130a′ may, according to one embodiment, be configured to set-up a joint session, being a session which is associated with the ongoing session, between the first and the second IODH, in response to having become aware of that, the at least parts of, the second IOD is allowed to take part in the ongoing session, so that such a joint session can be used for signaling, associated with the ongoing session, between the two IODHs.

For security reasons, the first IODH 130a′ may also be configured to assure that an updated IOD specific session key is provided to the second IOD. More specifically, the first IODH 130a′ may be configured to respond to the fact that it has become aware of that the at least parts of the second IOD is allowed to take part in the ongoing session by generating an IOD specific session key, associated with the second IOD and the ongoing session, or by requesting such a key from an EPA authenticator, or from an internal authentication function, if implemented on the first IODH 130a′, and transmitting the IOD specific session key to the second IODH. According to one embodiment, such an IOD specific session key may be accompanied by at least one of: a pointer to the server, providing the ongoing session, and a session ID, thereby allowing the second IODH 130a′ to identify the ongoing session. Furthermore, the IOD specific session key may also be transmitted together with an indication of capabilities that are allowed to participate in the ongoing session.

The first IODH 130a′ may be configured to manage at least parts of the second IOD by executing at least one of: adding at least part of the second IOD to the ongoing session, replacing at least part of an IOD managed by the first IODH with at least part of the second IOD, and deleting at least part of the second IOD from the ongoing session.

In some situations, it may be preferable to transfer the ongoing session from the first IODH, to the second IODH. In order to be able to handle such a situation, the first IODH 130a′ may be configured to transfer the ongoing session from the first IODH 130a′ to the second IODH, in case it is determined that it is preferable that the at least one parts of the IODs used by the ongoing session are instead managed by the second IODH. Such a transfer may be permanent, wherein the transfer will last until the ongoing session is terminated, or it may be temporary, so that it only proceed for a limited time of the remaining time of the session. The first IODH 130a, may, depending on the relevant configuration, either instruct the second IODH that a transfer is to be executed, or request the second IODH to accept such a transfer, after which the actual transfer can be executed, in case the second IODH accepts such a request.

A preference to transfer the ongoing session, as suggested above, may be based on various reasons. More specifically, the first IODH 130a′ may, according to one embodiment, be configured to support a transfer, based on at least one of: user preferences of the user of the UT; a determination that no IODs managed by the first IODH are participating in the active session any longer; a majority decision on the number of active IODs and/or capabilities involved in the session taken by at least the first and the second IODH, and a decision taken and provided by the server providing the ongoing session.

The computer readable instructions mentioned above, may, according to one aspect, be arranged as a computer program 730, and such a computer program 730, may form part of a computer program product 740, where the computer program product may be e.g. an optical disc, such as a Compact Disc (CD), a Digital Versatile Disc (DVD) or a Blu-Ray disc.

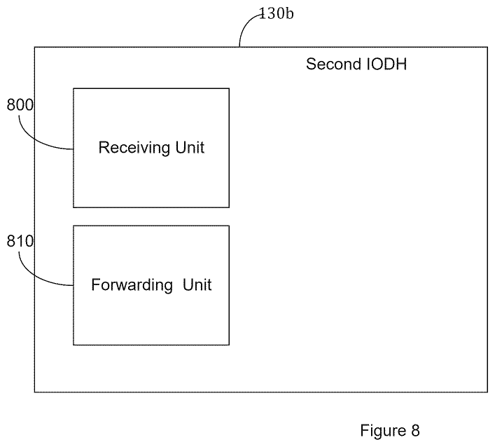

According to another aspect, another IODH, here referred to as a second IODH 130b, capable of providing IOD related information on an IOD which it is presently managing, to another IODH, as described herein, will now be described in further detail with reference to FIG. 8. The second IODH 130b, comprises a receiving unit 800, which is configured to receive information on a beacon signal from the second IOD, wherein the information comprises IOD specific information on the second IOD and session specific information on a session, wherein the session is ongoing via at least parts of a first IOD, managed by another IODH, here referred to as a first IODH, and a forwarding unit 810, configured to forward at least parts of the information on the beacon signal and an identity of the second IODH 130b to the first IODH.

The memory 910 can be any combination of random access memory (RAM) and/or read only memory (ROM). The memory 910 also comprises persistent storage, which, for example, can be any single one or combination of magnetic memory, optical memory, solid-state memory or even remotely mounted memory. The processing circuitry 900 may comprise e.g. one or more central processing unit (CPU), multiprocessor or digital signal processor (DSP).

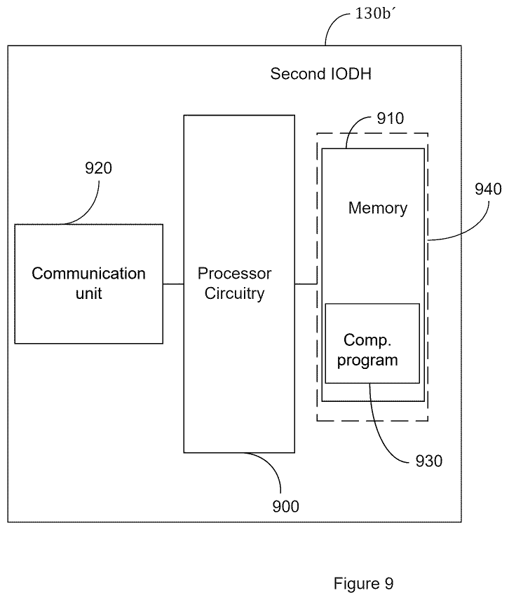

According to another aspect, a second IODH 130b′ is suggested, according to FIG. 9, where the second IODH 130b′ comprise processing circuitry 900 and memory 910, comprising computer readable instructions, which, when executed by the processing circuitry 900 causes the second IODH 130b′ to receive information on a beacon signal from the second IOD, via a communication unit 920, wherein the received information comprises IOD specific information on the second IOD and session specific information on a session, ongoing via at least parts of a first IOD, managed by a first IODH, and to forward at least parts of the information on the beacon signal and an identity of the second IODH 130b′, to the first IODH.

In case a message, indicating how a first IODH will react to forwarded information on the second IOD, is applied, the second IODH 130b′, may be configured to receive a reject message, indicating that no part of an IOD managed by the second IODH is allowed to take part in the ongoing session, or an accept message, indicating that at least a part of an IOD managed by the second IODH is allowed to take part in the ongoing session.

The received IOD specific information may comprise an identity of the second IOD, and an indication of the signal strength of the beacon signal when received by the second IOD, and wherein the session specific information comprises a session identity, and may, in addition, also comprise an indication of at least one capability, requested by the UT and/or an indication of at least one capability, available at the UT.

According to one embodiment, the second IODH 130b′ is configured to apply a joint session, associated with the ongoing session, and set up by the first IODH, for communication between the first and the second IODH, in response to having approved cooperation of the second IODH with the first IODH. In the latter situation, the second IODH 130b′ can be configured to act as a proxy between the first IODH and the second IODH 130b′, when using the joint session for forwarding of information.

For security reasons, the mentioned communication between the two IODHs may call for an IOD specific session key to be provided to the second IOD. In such a scenario, the second IODH 130b′ is configured to receive an IOD specific session key, associated with the second IOD and the ongoing session, from the first IODH, and to forward the IOD specific session key to the second IOD. Such an IOD specific session key may be received together with at least one of: an indication of capabilities that are allowed to participate in the ongoing session a pointer to the server, providing the ongoing session, and a session ID. In addition, such a key may be received together with an indication of capabilities that are allowed to participate in the ongoing session.

According to one embodiment, the second IODH 130b′ is configured to receive an accept message, indicating that at least part of the second IOD is allowed to take part in the ongoing session, or a reject message, indicating that at least part of the second IOD is prohibited from taking part in the ongoing session, from the first IODH. In case of an acceptance message, the second IODH 130b′ may be configured to recognize an accept message as a conditional acceptance, accepting that IODs managed by the second IODH are allowed to take part in the ongoing session only under certain conditions.

According to one embodiment, the second IODH 130b′ is configured to continue to forward beacon signal information, received by the second IOD and associated with the ongoing session until any of the following occurs at the second IODH: no more beacon signals comprising IOD specific information on the ongoing session is received by the second IODH, and the second IODH is receiving a reject message associated with the second IOD and the ongoing session, or the ongoing session is terminated.

According to one embodiment, the second IODH 130b′ is configured to receive an instruction or request, indicating that the managing of at least parts of the IODs used by the ongoing session is instructed or requested to be transferred to the second IODH.

The computer readable instructions mentioned above, may, according to one aspect, be arranged as a computer program 930, and such a computer program 930, may form part of a computer program product 940, where the computer program product may be e.g. an optical disc, such as a Compact Disc (CD), a Digital Versatile Disc (DVD) or a Blu-Ray disc.

Although IODHs are described as a first and a second IODH above, where these two IODHs have different roles in the described processes, it is to be understood that an IODH may be configured to hold one of the mentioned roles, exemplified as being executed on the first or the second IODH, respectively or, more typically, be capable of holding any of the two roles, once a demand for a respective role arises.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of a first IODH, managing a first set of IODs, comprising at least one first IOD, providing an ongoing session between a User Tag (UT), and a server, the method comprising:
receiving, from a second IODH, managing a second IOD of a second set of IODs, information on a beacon signal received by the second IOD, wherein the information comprises IOD specific information on the second IOD and session specific information on the ongoing session;
initiating, based at least partly on the received information, a determination on whether at least part of an IOD managed by the second IODH is allowed to or prohibited from taking part in the ongoing session, and
managing, at least parts of the second IOD to take part in the ongoing session, in response to having become aware of that the at least parts of the second IOD is allowed to take part in the ongoing session and based, at least partly on information on the beacon signal, received from the second IODH.

2. The method according to claim 1, wherein the IOD specific information comprise an identity of the second IOD, and an indication of the signal strength of the beacon signal when received by the second IOD, and wherein the session specific information comprises a session identity.

3-18. (canceled)

19. A method of a second IODH, handling information on a second IOD, managed by the second IODH, the method comprising:
receiving, from the second IOD, information on a beacon signal, wherein the information comprises IOD specific information on the second IOD and session specific information on a session, ongoing via at least parts of a first IOD, managed by a first IODH, and
forwarding, to the first IODH, at least parts of the information on the beacon signal and an identity of the second IODH;

20. The method according to claim 19, further comprising:
receiving, from the first IODH, a reject message, indicating that no part of an IOD managed by the second IODH is allowed to take part in the ongoing session, or,
receiving, from the first IODH, an accept message, indicating that at least a part of an IOD managed by the second IODH is allowed to take part in the ongoing session.

21-33. (canceled)

34. A first IODH, comprises processor circuitry, and a memory, comprising computer readable instructions, which, when executed by the processing circuitry, causes the first IODH to:
receive, from a second IODH, managing a second IOD of a second set of IODs, information on a beacon signal received by the second IOD, wherein the information comprises IOD specific information on the second IOD and session specific information on the ongoing session;
initiate, based at least partly on the received information, a determination on whether at least part of an IOD managed by the second IODH is allowed to or prohibited from taking part in the ongoing session, and
manage, at least parts of the second IOD to take part in the ongoing session, in response to having become aware of that the at least parts of the second IOD is allowed to take part in the ongoing session and based, at least partly on information on the beacon signal, received from the second IODH.

35. The first IODH according to claim 34, configured to handle IOD specific information comprising an identity of the second IOD, and an indication of the signal strength of the beacon signal when received by the second IOD, and to handle session specific information comprising a session identity.

36. The first IODH according to claim 35, further configured to handle IOD specific information, further comprising an indication of at least one capability, requested by the UT.

37. The first IODH according to claim 35, further configured to handle IOD specific information further comprising an indication of at least one capability, available at the second IOD.

38. The first IODH according to claim 35, configured to initiate the determining in response to having authenticated the beacon signal as a legitimate beacon signal.

39. The first IODH according to claim 35, configured to initiate the determining based on at least one of:
execution of a first policy available to the first IODH, and
a response to a request for the determination, transmitted to the server.

40. The first IODH according to claim 39, configured to initiate the determination based on execution of a first policy, available to the first IODH, wherein the first policy is based on at least one of:
IOD specific rules;
IOD domain specific rules,
IODH specific rules, and
service specific rules.

41. The first IODH according to claim 40, configured to apply a first policy, which is based on security classifications, wherein considering security classifications comprise at least one of:
comparing activities, executed by the ongoing session to at least one predefined security level, and
comparing at least parts of the second IOD to at least one predefined security level.

42. The first IODH according to claim 35, further configured to:
transmit, to the second IODH, an accept message, indicating that at least part of the second IOD is allowed to take part in the ongoing session, in case it was determined, by the first IODH, that such an action is allowed, or
transmit, to the second IODH, a reject message, indicating that at least part of the second IOD is prohibited from taking part in the ongoing session, in case it was determined, by the first IODH, that such an action is not allowed.

43. The first IODH according to claim 35, further configured to set-up, between the first and the second IODH, in response to having become aware of that the at least parts of the second IOD is allowed to take part in the ongoing session, a joint session, associated with the ongoing session.

44. The first IODH according to claim 35, further configured to, in response to having become aware of that the at least parts of the second IOD is allowed to take part in the ongoing session:
generate an IOD specific session key, associated with the second IOD and the ongoing session, and
transmit the IOD specific session key to the second IODH.

45. The first IODH according to claim 44, further configured to transmit the IOD specific session key together with at least one of:
a pointer to the server, providing the ongoing session, and
a session ID.

46. The first IODH according to claim 45, further configured to transmit the IOD specific session key together with an indication of capabilities that are allowed to participate in the ongoing session.

47. The first IODH according to claim 35, further configured to manage at least parts of the second IOD, wherein the managing comprises at least one of:
adding at least part of the second IOD to the ongoing session;
replacing at least part of an IOD managed by the first IODH with at least part of the second IOD, and
deleting at least part of the second IOD from the ongoing session.

48. The first IODH according to claim 35, further configured to:
transfer the ongoing session from the first IODH to the second IODH, in case it is determined that it is preferable that the at least one parts of the IODs used by the ongoing session are managed by the second IODH.

49. The first IODH according to claim 48, further configured to transfer the ongoing session only in case a request to transfer, sent to the second IODH results in an acceptance of the request from the second IODH.

50. The first IODH according to claim 48, further configured to execute the transfer as a temporary transfer.

51. The first IODH according to claim 35, further configured to prefer that the second IODH is managing the at least parts of the IODs used by the ongoing session based on at least one of:
user preferences of the user of the UT;
a determination that no IODs managed by the first IODH are participating in the active session any longer;
a majority decision on the number of active IODs and/or capabilities involved in the session taken by at least the first and the second IODH, and
a decision taken and provided by the server providing the ongoing session.

52. A second IODH comprising processor circuitry, and a memory, comprising computer readable instructions, which, when executed by the processing circuitry, causes the second IODH to:
receive, from the second IOD, information on a beacon signal, wherein the information comprises IOD specific information on the second IOD and session specific information on a session, ongoing via at least parts of a first IOD, managed by a first IODH, and
forward, to the first IODH, at least parts of the information on the beacon signal and an identity of the second IODH.

53. The second IODH according to claim 52, further configured to:
receive, from the first IODH, a reject message, indicating that no part of an IOD managed by the second IODH is allowed to take part in the ongoing session, or,
receive, from the first IODH, an accept message, indicating that at least a part of an IOD managed by the second IODH is allowed to take part in the ongoing session.

54. The second IODH according to claim 52, further configure to identify, within the IOD specific information, an identity of the second IOD, and an indication of the signal strength of the beacon signal when received by the second IOD, and session specific information comprising a session identity.

55. The second IODH (130b′) according to claim 54, further configured to identify IOD specific information comprising an indication of at least one capability, requested by the UT.

56. The second IODH according to claim 54, further configured to identify IOD specific information further comprising an indication of at least one capability, available at the UT.

57. The second IODH according to claim 52, further configured to use a joint session, associated with the ongoing session, set-up between the first and the second IODH, in response to having approved cooperation of the second IODH with the first IODH.

58. The second IODH according to claim 57, further configured to act as a proxy between the first IODH and the second IODH when using the joint session for forwarding of information.

59. The second IODH according to claim 52, further configured to:
receive, from the first IODH, an IOD specific session key, associated with the second IOD and the ongoing session, and
forward the IOD specific session key to the second IOD.

60. The second IODH according to claim 59, further configured to forward the IOD specific session key together with at least one of:
an indication of capabilities that are allowed to participate in the ongoing session;
a pointer to the server, providing the ongoing session, and
a session ID.

61. The second IODH according to claim 60, further configured to transmit the IOD specific session key together with an indication of capabilities that are allowed to participate in the ongoing session.

62. The second IODH according to claim 52, further configured to:
receive, from the first IODH, an accept message, indicating that at least part of the second IOD is allowed to take part in the ongoing session or a reject message, indicating that at least part of the second IOD is prohibited from taking part in the ongoing session.

63. The second IODH according to claim 62, further configured to interpret a received accept message as indicating a conditional acceptance, accepting that IODs managed by the second IODH are allowed to take part in the ongoing session only under certain conditions.

64. The second IODH according to claim 52, further configured to forward received beacon signal information, associated with the ongoing session until any of the following occurs at the second IODH:
no more beacon signals comprising IOD specific information on the ongoing session is received by the second IODH, and
the second IODH is receiving a reject message associated with the second IOD and the ongoing session, or
the ongoing session is terminated.

65. The second IODH according to claim 52, further configured to receive at least one of:
an instruction, indicating that the managing of at least parts of the IODs used by the ongoing session is to be transferred to the second IODH, or
a request, requesting the second IODH to accept a transfer of the managing of at least parts of the IODs used by the ongoing session is to be transferred to the second IODH.

66. The second IODH according to claim 65, configured to receive said request and further configured to participate in said transfer only in case the request is accepted by the second IODH.
